(19) United States
(12) Patent Application Publication
(10) Pub. No.: US 2018/0305544 A1
(43) Pub. Date: Oct. 25, 2018

(54) CURABLE COMPOSITIONS, ARTICLES THEREFROM AND METHODS OF MAKING COATED SUBSTRATES THEREWITH

(71) Applicant: 3M INNOVATIVE PROPERTIES COMPANY, St. Paul, MN (US)

(72) Inventors: Mario A. Perez, Burnsville, MN (US); Rajdeep S. Kalgutkar, Woodbury, MN (US); Raj Rajagopal, Woodbury, MN (US); Samantha J. Raney, St. Paul, MN (US)

(21) Appl. No.: 15/494,984

(22) Filed: Apr. 24, 2017

(51) Int. Cl. C08L 77/06; C08L 79/02; C09D 177/06; C09D 179/02; B05D 3/00

(52) U.S. Cl. CPC C08L 77/06; C08L 79/02; B05D 3/007; C09D 179/02; C09D 177/06

(57) ABSTRACT

The present invention generally relates to curable compositions that include a benzoxazine resin and a polyamide resin, wherein the polyamide resin is a reaction product of (i) a dicarboxylic acid, wherein the dicarboxylic acid includes a non-aromatic, dicarboxylic dimer acid and the mole fraction of the non-aromatic, dicarboxylic dimer acid is between from 0.10 to 1.00, based on the total moles of dicarboxylic acid used to form the polyamide resin; and (ii) a diamine; and wherein the polyamide resin is amine terminated and includes amine end-groups. The curable compositions may be used to produce an article comprising a cured composition wherein the cured composition is the reaction product of the curable composition according to any one of the curable compositions of the present disclosure. The present invention also relates to methods of coating substrates using the curable compositions of the present disclosure.

### FIELD

The present invention generally relates to curable compositions that include a benzoxazine resin and a polyamide resin. The curable compositions may be used, for example, as coatings for a substrate. The present invention also relates to methods of coating substrates using the curable compositions of the present disclosure.

### BACKGROUND

Curable compositions base on benzoxazine resins have been disclosed in the art. Such curable compositions are described in, for example, U.S. Pat. Nos. 8,716,377 B2 and 9,228,112 B2 and U.S. Pat. Publ. Nos. 2015/0031819 A1 and 2016/0289403 A1.

### SUMMARY

In one embodiment, the present disclosure provides curable composition comprising:

a benzoxazine resin; and a polyamide resin, wherein the polyamide resin is a reaction product of (i) a dicarboxylic acid, wherein the dicarboxylic acid includes a non-aromatic, dicarboxylic dimer acid and the mole fraction of non-aromatic, dicarboxylic dimer acid is between from 0.10 to 1.00, based on the total moles of dicarboxylic acid used to form the polyamide resin; and (ii) a diamine; and wherein the polyamide resin is amine terminated and includes amine end-groups. In another embodiment, the present disclosure provides an article comprising a cured composition, wherein the cured composition is the reaction product of the curable composition according to any one of the curable compositions of the present disclosure and, optionally, wherein at least 10 mole percent of the amine end-groups of the polyamide resin of the curable composition have reacted. In yet another embodiment, the present disclosure provides a method of coating a substrate including; providing a curable composition according to any one of the curable compositions of the present disclosure, wherein the curable composition is in the form of a powder, curable composition; providing a substrate having a surface; electrostatically coating the powder, curable composition onto the substrate surface; and optionally, curing the powder, curable composition. The curable compositions of the present disclosure may be useful as a coating, a primer, a sealant or an adhesive, for example.

In some embodiments, the cured compositions are useful as corrosion-resistant coatings and have application where metal substrates or structures become subject to oxidative corrosion and ultimately fail to fulfill their intended purpose. Examples of failure by metal corrosion include deterioration of heat exchanger elements, corrosion of pipeline distribution systems and especially the gradual disintegration of steel used for reinforcing concrete structures such as bridge decks and frames which support a wide range of modern buildings. The curable compositions are particularly useful in providing corrosion protection to substrates exposed to high operating temperatures, such as in excess of 180° C. or even in excess of 220° C.

As used herein the term “benzoxazine” is inclusive of compounds and polymers having the characteristic benzoxazine ring. In the illustrated benzoxazine group, R is the residue of a mono- or polyamine.

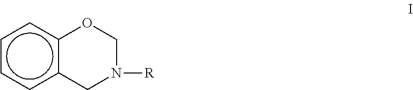

where R represents a (hetero)hydrocarbyl groups, including (hetero)alkyl and (hetero)aryl groups.

As used herein, “alkyl” and “alkylene” mean the monovalent and divalent residues remaining after removal of one and two hydrogen atoms, respectively, from a linear or branched chain hydrocarbon having 1 to 20 carbon atoms. Examples of “alkyl” as used herein include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, and norbornyl. and the like. Unless otherwise noted, alkyl groups may be mono- or polyvalent.

As used herein, the term “heteroalkyl” includes both straight-chained, branched, and cyclic alkyl groups with one or more heteroatoms independently selected from S, O, and N both unsubstituted and substituted alkyl groups. Unless otherwise indicated, the heteroalkyl groups typically contain from 1 to 20 carbon atoms. “Heteroalkyl” is a subset of “heterohydrocarbyl” described below. Examples of “heteroalkyl” as used herein include, but are not limited to methoxy, ethoxy, propoxy, 3,6-dioxaheptyl, 3-(trimethylsilyl)-propyl, 4-dimethylaminobutanyl, and the like. Unless otherwise noted, heteroalkyl groups may be mono- or polyvalent.

“aryl” and “arylene” mean the monovalent and divalent residues remaining after removal of one and two hydrogen atoms, respectively, from an aromatic compound (single ring and multi- and fused-rings) having 5 to 12 ring atoms and includes substituted aromatics such as lower alkaryl and aralkyl, lower alkoxy, N,N-di(lower alkyl)amino, nitro, cyano, halo, and lower alkyl carboxylic ester, wherein “lower” means C₁ to C₄.

Unless otherwise noted, aryl and heteroaryl groups may be mono- or polyvalent.

As used herein “(hetero)hydrocarbyl” is inclusive of hydrocarbyl alkyl and aryl groups, and heterohydrocarbyl heteroalkyl and heteroaryl groups. Heterohydrocarbyl may optionally contain one or more catenary (in-chain) functional groups including ester, amide, urea, urethane and carbonate functional groups. Unless otherwise indicated, the non-polymeric (hetero)hydrocarbyl groups typically contain from 1 to 60 carbon atoms. Some examples of such (hetero)hydrocarbyls as used herein include, but are not limited to methoxy, ethoxy, propoxy, 4-diphenylaminobutyl, 2-(2′-phenoxyethoxy)ethyl, 3,6-dioxaheptyl, 3,6-dioxahexyl-6-phenyl, in addition to those described for “alkyl”, “heteroalkyl”, “aryl” and “heteroaryl” supra.

As used herein the term “residue” is used to define that (hetero)hydrocarbyl portion of a group remaining after removal (or reaction) of the attached functional groups, or the attached groups in a depicted formula. For example, the “residue” of butyraldehyde, C₄H₉—CHO is the monovalent alkyl C₄H₉—. The residue of hexamethylene diamine, H₂N—C₆H₁₂—NH₂ is the divalent alkyl —C₆H₁₂—. The residue of phenylene diamine H₂N—C₆H₄—NH₂, is the divalent aryl —C₆H₄—. The residue of diamino-polyethylene glycol, H₂N—(C₂H₄O)₁₋₂₀—C₂H₄—NH₂, is the divalent (hetero)hydrocarbyl polyethylene glycol —(C₂H₄O)₁₋₂₀—C₂H₄—.

Repeated use of reference characters in the specification is intended to represent the same or analogous features or elements of the disclosure. As used herein, the word “between”, as applied to numerical ranges, includes the endpoints of the ranges, unless otherwise specified. The recitation of numerical ranges by endpoints includes all numbers within that range (e.g. 1 to 5 includes 1, 1.5, 2, 2.75, 3, 3.80, 4, and 5) and any range within that range.

It should be understood that numerous other modifications and embodiments can be devised by those skilled in the art, which fall within the scope and spirit of the principles of the disclosure. All scientific and technical terms used herein have meanings commonly used in the art unless otherwise specified. The definitions provided herein are to facilitate understanding of certain terms used frequently herein and are not meant to limit the scope of the present disclosure. As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

### DETAILED DESCRIPTION

In the preparation of the benzoxazine-polyamide compositions of the present disclosure, any benzoxazine compound may be used, bisphenol-F-benzoxazines and bisphenol-A-benzoxazines providing particular utility. The benzoxazine resin may be mono- or higher functionality, e.g. difunctional. In some embodiments, the benzoxazine reisin is di- or higher functionality. In some embodiments, the benzoxazine resin is a liquid at room temperature. In some embodiments, the benzoxazine is a solid, e.g. a powder, at room temperature.

Benzoxazines may be prepared by combining a phenolic compound, and aliphatic aldehyde, and a primary amine compound. U.S. Pat. No. 5,543,516 (Ishida), hereby incorporated by reference, describes a solventless method of forming benzoxazines. U.S. Pat. No. 7,041,772 (Aizawa et al.) describes a process for producing a benzoxazine resin which comprises the steps of reacting a phenol compound, an aldehyde compound and a primary amine in the presence of an organic solvent to synthesize a benzoxazine resin and removing generated condensation water and the organic solvent from a system under heating and a reduced pressure. Other suitable reaction schemes to produce mono-, di- and higher-functional benzoxazines are described in N. N. Ghosh et al., Polybenzoxazine-new high performance thermosetting resins: synthesis and properties, Prog. Polym. Sci. 32 (2007), pp. 1344-1391. One suitable method of producing the starting benzoxazine compounds is illustrated by the following reaction scheme:

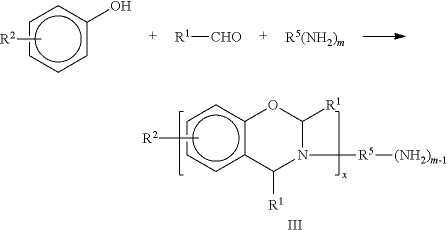

wherein
each R¹ is H or an alkyl group, and is the residue of an aliphatic aldehyde,
R² is H, a covalent bond, or a polyvalent (hetero)hydrocarbyl group, preferably H, a covalent bond or a divalent alkyl group;
R⁵ is the (hetero)hydrocarbyl residue of a primary amino compound, R⁵(NH₂)ₘ, where m is 1-6; and
x is at least 1. It will be understood that the free amino groups depicted may further react to produce additional benzoxazine groups.

A monophenol is illustrated for simplicity. Mono- or polyphenolic compounds may be used. The phenolic compound may be further substituted without limitation is desired. For example, the 3, 4, and 5 positions of the phenolic compound may be hydrogen or substituted with other suitable substituents such as alkyl, cycloalkyl, heterocycloalkyl, aryl, heteroaryl, aralkyl, heteroaralkyl, alkoxy, alkoxyalkylene, hydroxylalkyl, hydroxyl, haloalkyl, carboxyl, halo, amino, aminoalkyl, alkylcarbonyloxy, alkyloxycarbonyl, alkylcarbonyl, alkylcarbonylamino, aminocarbonyl, alkylsulfonylamino, aminosulfonyl, sulfonic acid, or alkylsulfonyl. Desirably at least one of the positions ortho to the hydroxyl group is unsubstituted to facilitate benzoxazine ring formation.

With respect to the R² group of Formula III, numerous phenolic compounds are contemplated. R² may be an H, a covalent bond “-” which represents a biphenyl-type phenolic compounds, or R² may be a divalent aliphatic group linking aryl rings. For example, R² may be a divalent methyl group or a divalent isopropyl group, derived from bisphenol-A, generally illustrated as follows:

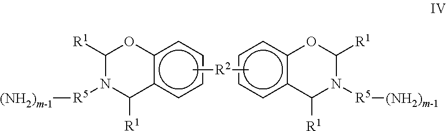

where
each R¹ is H or an alkyl group, and is the residue of an aliphatic aldehyde,
R² is H, a covalent bond, or a polyvalent (hetero)hydrocarbyl group, preferably H, a covalent bond or a divalent alkyl group;
R⁵ is the (hetero)hydrocarbyl residue of a primary amino compound, R⁵(NH₂)ₘ, where m is 1-6. It will be understood that the free amino groups depicted may further react to produce additional benzoxazine groups.

The aryl ring of the phenolic compound may be a phenyl ring as depicted, or may be selected from naphthyl, biphenyl, phenanthryl, and anthracyl. The aryl ring of the phenolic compound may further comprise a heteroaryl ring containing 1-3 heteroatoms such as nitrogen, oxygen, or sulfur and can contain fused rings. Some examples of heteroaryl are pyridyl, furanyl, pyrrolyl, thienyl, thiazolyl, oxazolyl, imidazolyl, indolyl, benzofuranyl, and benzthiazolyl.

Examples or mono-functional phenols include phenol; cresol; 2-bromo-4-methylphenol; 2-allyphenol; 4-aminophenol; and the like. Examples of difunctional phenols (polyphenolic compounds) include phenolphthalein; biphenol, 4-4′-methylene-di-phenol; 4-4′-dihydroxybenzophenone; bisphenol-A; 1,8-dihydroxyanthraquinone; 1,6-dihydroxnaphthalene; 2,2′-dihydroxyazobenzene; resorcinol; fluorene bisphenol; and the like. Examples of trifunctional phenols comprise 1,3,5-trihydroxy benzene and the like.

The aldehyde reactants used in preparing the benzoxazine starting materials include formaldehyde; paraformaldehyde; polyoxymethylene; as well as aldehydes having the general formula R¹CHO, where R¹ is H or an alkyl group, including mixtures of such aldehydes, desirably having from 1 to 12 carbon atoms. The R¹ group may be linear or branched, cyclic or acyclic, saturated or unsaturated, or combinations thereof other useful aldehydes include crotonaldehyde; acetaldehyde; propionaldehyde; butyraldehyde; and heptaldehyde.

Amino compounds useful in preparing the starting benzoxazine can be substituted or unsubstituted, mono-, di-substituted or higher (hetero)hydrocarbyl amines having at least one primary amine group. The amines may be aliphatic or aromatic amines. It can be substituted, for example, with groups such as alkyl, cycloalkyl, heterocycloalkyl, aryl, heteroaryl, aralkyl, or heteroaralkyl. It has been observed that benzoxazines derived from aromatic amines, such as aniline, are less reactive toward the thiol reactants than benzoxazines derived from aliphatic amines as indicated, for example by the corresponding reaction temperatures.

Amines useful in the preparation of the starting benzoxazine compounds include those of the formula:

R⁵(NH₂)ₘ V

and include (hetero)hydrocarbyl monoamines and polyamines. R⁵ may be (hetero)hydrocarbyl group that has a valence of m, and is the residue of a mono-, di- or higher amine having at least one primary amine group. R⁵ can be an alkyl, a cycloalkyl or aryl and m 1 to 6. The R⁵ is preferably selected from mono- and polyvalent (hetero)hydrocarbyl (i.e., alkyl and aryl compounds having 1 to 30 carbon atoms, or alternatively (hetero)hydrocarbyl including heteroalkyl and heteroaryl having 1 to twenty heteroatoms of oxygen.

In one embodiment, R⁵ comprises a non-polymeric aliphatic, cycloaliphatic, aromatic or alkyl-substituted aromatic moiety having from 1 to 30 carbon atoms. In another embodiment, R⁵ comprises a polymeric polyoxyalkylene, polyester, polyolefin, poly(meth)acrylate, polystyrene or polysiloxane polymer having pendent or terminal reactive —NH₂ groups. Useful polymers include, for example, amine-terminated oligo- and poly-(diaryl)siloxanes and (dialkyl)siloxane amino terminated polyethylenes or polypropylenes, and amino terminated poly(alkylene oxides).

Any primary amine may be employed. Useful monoamines include, for example, methyl-, ethyl-, propyl-, hexyl-, octyl, dodecyl-, dimethyl-, methyl ethyl-, and aniline. The term “di-, or polyamine,” refers to organic compounds containing at least two primary amine groups. Aliphatic, aromatic, cycloaliphatic, and oligomeric di- and polyamines all are considered useful in the practice of the invention. Representative of the classes of useful di- or polyamines are 4,4′-methylene dianiline, 3,9-bis-(3-aminopropyl)-2,4,8,10-tetraoxaspiro[5,5]undecane, and polyoxyethylenediamine. Useful diamines include N-methyl-1,3-propanediamine; N-ethyl-1,2-ethanediamine; 2-(2-aminoethylamino)ethanol; pentaethylenehexaamine; ethylenediamine; N-methylethanolamine; and 1,3-propanediamine.

Examples of useful polyamines include polyamines having at least three amino groups, wherein at least one of the three amino groups are primary, and the remaining may be primary, secondary, or a combination thereof. Examples include H₂N(CH₂CH₂NH)₁₋₁₀H, H₂N(CH₂CH₂CH₂CH₂NH)₁₋₁₀H, H₂N(CH₂CH₂CH₂CH₂CH₂CH₂NH)₁₋₁₀H, H₂N(CH₂)₃NHCH₂CH═CHCH₂NH(CH₂)₃NH₂, H₂N(CH₂)₄NH(CH₂)₃NH₂, H₂N(CH₂)₃NH(CH₂)₄NH(CH₂)₃NH₂, H₂N(CH₂)₃NH(CH₂)₂NH(CH₂)₃NH₂, H₂N(CH₂)₂NH(CH₂)₃NH(CH₂)₂NH₂, H₂N(CH₂)₃NH(CH₂)₂NH₂, C₆H₅NH(CH₂)₂NH(CH₂)₂NH₂, and N(CH₂CH₂NH₂)₃, and polymeric polyamines such as linear or branched (including dendrimers) homopolymers and copolymers of ethyleneimine (i.e., aziridine). Many such compounds can be obtained, or are available, from general chemical suppliers such as, for example, Aldrich Chemical Company, Milwaukee, Wis. or Pfaltz and Bauer, Inc., Waterbury, Conn.

Many di- and polyamines, such as those just named, are available commercially, for example, those available from Huntsman Chemical, Houston, Tex. The most preferred di- or polyamines include aliphatic di- and triamines or aliphatic di- or polyamines and more specifically compounds with two or three primary amino groups, such as ethylene diamine, hexamethylene diamine, dodecanediamine, and the like.

Other useful amines include amino acids such as glycine, alanine, and leucine and their methyl esters, aminoalcohols such as ethanolamine, 3-aminopropanol, and 4-aminobutanol, polyaminoethers containing ethylene glycol and diethylene glycol (such as Jeffamine™ diamines), and alkenyl amines such as diallylamine and allylmethylamine.

For many embodiments, it is preferable that the amine of Formula V be selected from aromatic-containing amines, i.e. R⁵ is an aryl, alkyaryl or aralkyl group. Such benzoxazine—polyamine adducts, where the polyamine has an aromatic groups, has generally performance when exposed to higher temperatures.

It will be understood that monoamines will cyclize with the aldehyde and phenolic compound to produce mono-benzoxazine compounds, while di- or higher amines will cyclize to produce di- and poly-benzoxazine compounds: For example, a diamine (m=2 in the Scheme VI below) will produce a di-benzoxazine.

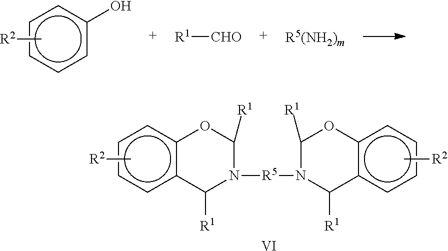

wherein each R¹ is H or an alkyl group, and R¹ is the residue of an aliphatic aldehyde;
R² is H, a covalent bond, or a polyvalent (hetero)hydrocarbyl group, preferably H, a covalent bond or a divalent alkyl group;
R⁵ is the (hetero)hydrocarbyl residue of a primary amino compound
and m is 2.

If a polyamine and a polyphenol are used in the preparation, a polybenzoxazine will result. As used herein the term “polybenzoxazine” will refer to compounds having two or more benzoxazine rings. The term “poly(benzoxazine)” will refer to polymers resulting from ring-opening and homopolymerization of benzoxazine compounds.

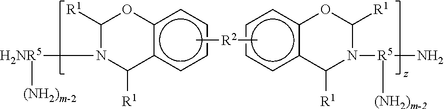

wherein,
each of R¹ is H or an alkyl group;
R² is a covalent bond, or a divalent (hetero)hydrocarbyl group;
m is 2-4;
z is at least 2;
R⁵ is the divalent (hetero)hydrocarbyl residue of a primary diamino compound.

The polyamide resin of the present disclosure is the reaction product of (i) a dicarboxylic acid, wherein the dicarboxylic acid includes a dicarboxylic dimer acid, and the mole fraction of the dicarboxylic dimer acid is between from 0.10 to 1.00, based on the total moles of dicarboxylic acid used to form the polyamide resin; and (ii) a diamine; and wherein the polyamide resin is amine terminated and includes amine end-groups. In some embodiments, the polyamide resin of the present disclosure is the reaction product of (i) a dicarboxylic acid, wherein the dicarboxylic acid includes a non-aromatic, dicarboxylic dimer acid and the mole fraction of non-aromatic, dicarboxylic dimer acid is between from 0.10 to 1.00, based on the total moles of dicarboxylic acid used to form the polyamide resin; and (ii) a diamine; and wherein the polyamide resin is amine terminated and includes amine end-groups. The use of at least 10 mole percent (i.e. a mole fraction of 0.1) of the dimer acid, e.g. non-aromatic dimer acid, imparts unique properties on the resulting polyamide resin. The dimer acid disrupts the structural regularity of the polyamide, thereby significantly reducing or eliminating crystallinity while retaining H-bonding interactions in the resulting polyamide resin. Surprisingly, the polyamide resin of the present disclosure, which include amine termination, functions both as a curative for the curable compositions of the present disclosure and a toughening agent. Although not wishing to be bound by theory, it is thought that the reduction and/or elimination of the crystallinity of the polyamide resin imparts enhanced toughening and flexibility characteristics in the curable compositions of the present disclosure, once they have been cured.

The dicarboxylic acid useful in the synthesis of the polyamide resin of the present disclosure is not particularly limited, except that the dicarboxylic acid, includes a dicarboxylic dimer acid and the mole fraction of the dicarboxylic dimer acid is between from 0.10 to 1.00, based on the total moles of dicarboxylic acid used to form the polyamide resin. The dicarboxylic acid may include at least one alkyl or alkenyl group and may contain 3 to 30 carbon atoms and is characterized by having two carboxylic acid groups. The alkyl or alkenyl group may be branched. The alkyl group may be cyclic. Useful dicarboxylic acids may include propanedioic acid, butanedioic acid, pentanedioic acid, hexanedioic acid, heptanedioic acid, octanedioic acid, nonanedioic acid, decanedioic acid, undecanedioic acid, dodecanedioic acid, hexadecanedioic acid, (Z)-Butenedioic acid, (E)-Butenedioic acid, pent-2-enedioic acid, dodec-2-enedioic acid, (2Z)-2-Methylbut-2-enedioic acid, (2E,4E)-Hexa-2,4-dienedioic acid. Aromatic dicarboxylic acids may be used, such as phthalic acid, isophthalic acid, terephthalic acid and 2,6-naphthalenedicarboxylic acid. However, due to their aromatic structure, the aromatic dicarboxylic acids may decrease the flexibility of the polyamide resin, which may limit their utility in some applications. In some embodiments, the dicarboxylic acid contains between from 0 to 30 percent, between from 0 to 20 percent, between from 0 to 10 percent, between from 0 to 5 percent or even between from 0 and 2 percent of an aromatic dicarboxylic acid, based on the total moles of dicarboxylic acid used to form the polyamide resin. An aromatic dicarboxylic acid is defined as a dicarboxylic acid wherein the ratio, Rc, of the number of carbon atoms in the aromatic group or groups to the total number of carbon atoms in the dicarboxylic acid is at least 0.25, at least 0.33, at least 0.37, at least 0.42, at least 0.5, at least 0.6 or even higher. For example, terephthalic acid has a total of 8 carbon atoms, 6 being in the aryl group. Hence the ratio, Rc, would equal 0.75. Mixtures of two or more dicarboxylic acid may be used and may be preferred, as mixtures of different dicarboxylic acids will aid in disrupting the structural regularity of the polyamide, thereby significantly reducing or eliminating crystallinity in the resulting polyamide resin.

The dicarboxylic dimer acid useful in the synthesis of the polyamide resin present disclosure is not particularly limited. The dicarboxylic dimer acid may include at least one alkyl or alkenyl group and may contain 12 to 100 carbon atoms, 16 to 100 carbon atoms or even 18 to 100 carbon atom and is characterized by having two carboxylic acid groups. The dimer acid may be saturated or partially unsaturated. In some embodiments, the dimer acid may be a dimer of a fatty acid. The phrase “fatty acid,” as used herein means an organic compound composed of an alkyl or alkenyl group containing 5 to 22 carbon atoms and characterized by a terminal carboxylic acid group. Useful fatty acids are disclosed in “Fatty Acids in Industry: Processes, Properties, Derivatives, Applications”, Chapter 7, pp 153-175, Marcel Dekker, Inc., 1989. In some embodiments, the dimer acid may be formed by the dimerization of unsaturated fatty acids having 18 carbon atoms such as oleic acid or tall oil fatty acid. The dimer acids are often at least partially unsaturated and often contain 36 carbon atoms. The dimer acids may be relatively high molecular weight and made up of mixtures comprising various ratios of a variety of large or relatively high molecular weight substituted cyclohexenecarboxylic acids, predominately 36-carbon dicarboxylic dimer acid. Component structures may be acyclic, cyclic (monocyclic or bicyclic) or aromatic, as shown below. Note that the dimer acid structure below which includes an aromatic ring would be considered to be a non-aromatic dicarboxylic acid, as Rc would be 0.167.

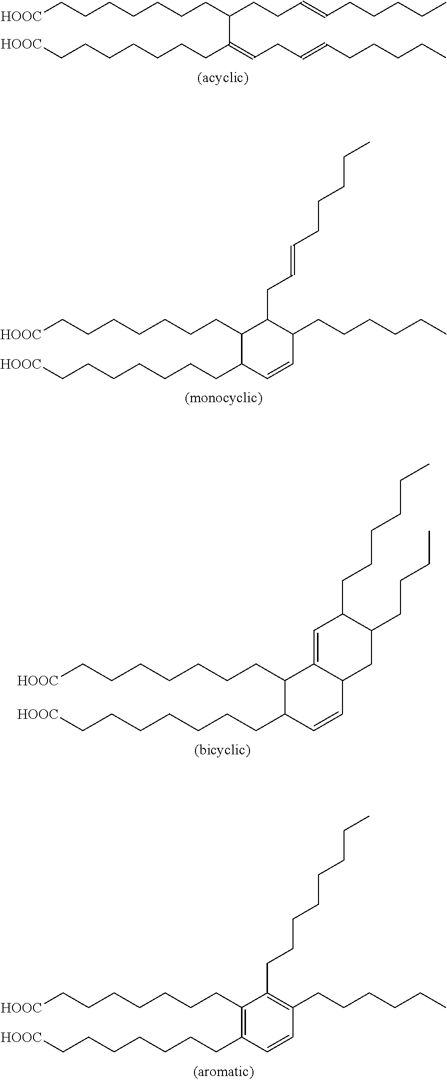 [SMILES: CCCCC/C=C/C/C=C(/CCCCCCCC(=O)O)C(CC/C=C/CCCCC)CCCCCCCC(=O)O ; CCCCC/C=C/CC1C(CCCCCC)C=CC(CCCCCCCC(=O)O)C1CCCCCCCC(=O)O ; CCCCCCC1C=C2C(C=CC(CCCCCCCC(=O)O)C2CCCCCCCC(=O)O)CC1CCCC ; CCCCCCCCc1c(CCCCCC)ccc(CCCCCCCC(=O)O)c1CCCCCCCC(=O)O]

The dimer acids may be prepared by condensing unsaturated monofunctional carboxylic acids such as oleic, linolcic, soya or tall oil acid through their olefinically unsaturated groups, in the presence of catalysts such as acidic clays. The distribution of the various structures in dimer acids (nominally C₃₆ dibasic acids) depends upon the unsaturated acid used in their manufacture. Typically, oleic acid gives a dicarboxylic dimer acid containing about 38% acyclics, about 56% mono- and bicyclics, and about 6% aromatics. Soya acid gives a dicarboxvlic dimer acid containing about 24% acyclics, about 58% mono- and bicyclics and about 18% aromatics. Tall oil acid gives a dicarboxylic dimer acid containing about 13% acyclics, about 75% mono- and bicyclics and about 12% aromatics. The dimerization procedure also produces trimer acids. The commercial dimer acid products are typically purified by distillation to produce a range of dicarboxylic acid content. Useful dimer acids contain at least 80% dicarboxylic acid, more preferably 90% dicarboxylic acid content, even more preferably at least 95% dicarboxylic acid content. For certain applications it may be advantageous to further purify the dimer acid by color reduction techniques including hydrogenation of the unsaturation, as disclosed in U.S. Pat. No. 3,595,887, which is incorporate herein by reference in its entirety. Hydrogenated dimer acids may also provide increased oxidative stability at elevated temperatures. Other useful dimer acids are disclosed in Kirk-Othmer Encyclopedia of Chemical Technology, Organic Chemicals: Dimer Acids (ISBN 9780471238966), copyright 1999-2014, John Wiley and Sons, Inc. Useful dimer acids contain at least 80% dicarboxylic acid, more preferably 90% dicarboxylic acid content, even more preferably at least 95% dicarboxylic acid content. For certain applications it may be advantageous to further purify the dimer acid by color reduction techniques including hydrogenation of the unsaturation, as disclosed in U.S. Pat. No. 3,595,887, which is incorporate herein by reference in its entirety. Hydrogenated dimer acids may also provide increased oxidative stability at elevated temperatures. Other useful dimer acids are disclosed in Kirk-Othmer Encyclopedia of Chemical Technology, Organic Chemicals: Dimer Acids (ISBN 9780471238966), copyright 1999-2014, John Wiley and Sons, Inc. Commercially available dicarboxylic dimer acid are available under the trade designation EMPOL 1008 and EMPOL 1061 both from BASF, Florham Park, N.J. and PRIPOL 1006, PRIPOL 1009, PRIPOL 1013. PRIPOL 1017 and PRIPOL 1025 all from Coroda Inc., Edison, N.J., for example.

In some embodiments, the number average molecular weight of the dicarboxylic dimer acid, e.g. the non-aromatic dicarboxylic dimer acid, may be between from 300 g/mol to 1400 g/mol, between from 300 g/mol to 1200 g/mol, between from 300 g/mol to 1000 g/mol or even between from 300 g/mol to 800 g/mol. In some embodiments, the number of carbon atoms in the dicarboxylic dimer acid, e.g. the non-aromatic dicarboxylic dimer acid, may be between from 12 to 100, between from 20 to 100, between from 30 to 100, between from 12 to 80, between from 20 to 80, between from 30 to 80, between from 12 to 60, between from 20 to 60 or even between from 30 to 60. The mole fraction of dicarboxylic dimer acid, e.g. non-aromatic, dicarboxylic dimer acid, included as the dicarboxylic acid, is between from 0.10 to 1.00, based on the total moles of dicarboxylic acid used to form the polyamide resin. In some embodiments the, mole fraction of dicarboxylic dimer acid, e.g. non-aromatic, dicarboxylic dimer acid, included as the dicarboxylic acid, is between from 0.10 to 1.00, between from 0.30 to 1.00, between from 0.50 to 1.00, between from 0.70 to 1.00, between from 0.80 to 1.00, between from 0.90 to 1.00, between from 0.10 to 0.95, between from 0.30 to 0.95, between from 0.50 to 0.95, between from 0.70 to 0.95, between from 0.80 to 0.95, or even between from 0.90 to 0.95, based on the total moles of dicarboxylic acid used to form the polyamide resin. In some embodiments, the mole fraction of dicarboxylic dimer acid, e.g. non-aromatic, dicarboxylic dimer acid, included as the dicarboxylic acid, is 1.00, based on the total moles of dicarboxylic acid used to form the polyamide resin. Mixtures of two or more dimer acids may be used.

The diamine useful in the synthesis of the polyamide resin of the present disclosure is not particularly limited. The diamines are often alkylene diamines or heteroalkylene diamines. The previously disclosed diamines used in the synthesis of the benzoxazine resin may be used in the synthesis of the polyamide resin. Preferred diamines have the formula H₂NRⁿNH₂ where Rⁿ can be a linear or branched aliphatic, cycloaliphatic or aromatic group. R can also be a polyether linkage such that the diamine belongs to the family of diamines sold under the trade designation “JEFFAMINE” from Huntsman Corp, Salt Lake City. Utah. The diamine can also be an amine terminated butadiene or butadiene-acrylonitrile such as those sold under the trade designation “HYPRO” from CVC Thermoset Specialties, a division of Emerald Performance Materials, Moorestown, N.J. The diamine can also be a dimer diamine such as those sold under the trade designation “PRIAMINE” from Croda, Inc., New Castle, Del. Mixtures of diamines may be used. Aromatic diamines may also be used. However, in some embodiments, the diamine is free of aryl moiety, i.e. the diamine does not contain an aryl moiety. The diamines may be low molecular weight molecules, oligomeric molecules or even low molecular weight polymer molecules. The diamines may be amine terminated polymers, e.g. at least one of amine terminated polyethylene glycol, and amine terminated polypropylene glycol. In some embodiments the diamine has the following structure: H₂NR⁴NH₂, where R⁴ is at least one of an aliphatic, cycloaliphatic and aromatic hydrocarbon having from 2 to 20 carbon atoms. In some embodiments the diamine has the following structure: H₂NR⁴NR⁴H, where R⁴ is at least one of an aliphatic, cycloaliphatic and aromatic hydrocarbon having from 2 to 20 carbon atoms. In some embodiments the diamine has the following structure: HR⁴NR⁴NR⁴H, where R⁴ is at least one of an aliphatic, cycloaliphatic and aromatic hydrocarbon having from 2 to 20 carbon atoms. The R⁴ groups on the two ends can cyclize as is the case with piperazine. Other examples include, but are not limited to, aminoethylpiperazine (mixed primary and secondary diamine); 4,4′-(1,3-propanediyl)bispiperidine; 1,3-Di-4-piperidylpropane available under the trade designation “DIPIP” from Vertellus Industrial Specialties, Indianapolis, Ind.; a cycloaliphatic bis(secondary amine) available under the trade designation “JEFFLINK 754 DIAMINE” from Huntsman International, LLC, Salt Lake City, Utah and an aliphatic secondary diamine available under the trade designation “CLEARLINK 1000” from Dorf Ketal. Houston, Tex. Combinations of two or more of the various diamines may be used. In some embodiments, secondary diamines may be used alone or in combination with primary diamines. Secondary amines may help reduce the density of the H-bond network which can contribute to improve toughening. By varying the ratio of primary diamine and secondary diamine, one can alter the mechanical properties, e.g. modulus, of the cured, curable composition.

In some embodiments, the number average molecular weight of the diamine is between from 60 g/mol to 10000 g/mol, between from 60 g/mol to 5000 g/mol, between from 60 g/mol to 4000 g/mol, between from 60 g/mol to 3000 g/mol, between from 100 g/mol to 10000 g/mol, between from 100 g/mol to 5000 g/mol, between from 100 g/mol to 4000 g/mol, between from 100 g/mol to 3000 g/mol, between from 200 g/mol to 10000 g/mol, between from 200 g/mol to 5000 g/mol, between from 200 g/mol to 4000 g/mol or even between from 200 g/mol to 3000 g/mol. The amine groups of the diamine may be at least one of a primary amine and a secondary amine. In some embodiments, the amine groups of the diamine may both be primary amines. In some embodiments, the amine groups of the diamine may both be secondary amines. In some embodiments, the amine groups of the diamine may be a primary amine and a secondary amine. Mixtures of amines having two primary amines, two secondary amines or a primary and a secondary amine may be used.

The polyamide resins of the present disclosure may be formed following a conventional condensation reaction between at least one dicarboxylic acid and at least one diamine. Mixtures of at least two dicarboxylic acid types with at least one diamine, mixtures of at least two diamine types with at least one dicarboxylic acid or mixtures of at least two dicarboxylic acid types with at least two diamine types may be used. The polyamide resins of the present disclosure are amine terminated and includes amine end-groups. Amine termination can be obtained by using the appropriate stoichiometric ratio of amine groups to acid groups, e.g. the appropriate stoichiometric ratio of diamine and dicarboxylic acid during the synthesis of the polyamide. In some embodiments, the mole ratio of diamine to dicarboxylic acid is between from 1.01/1.00 to 2.00/1.00, between from 1.01/1.00 to 1.90/1.00, between from 1.01/1.00 to 1.80/1.00, between from 1.01/1.00 to 1.70/1.00, between from 1.01/1.00 to 1.60/1.00, between from 1.01/1.00 to 1.50/1.00, between from 1.01/1.00 to 1.40/1.00, between from 1.05/1.00 to 2.00/1.00, between from 1.05/1.00 to 1.90/1.00, between from 1.05/1.00 to 1.80/1.00, between from 1.05/1.00 to 1.70/1.00, between from 1.05/1.00 to 1.60/1.00, between from 1.05/1.00 to 1.50/1.00, between from 1.05/1.00 to 1.40/1.00, between from 1.10/1.00 to 2.00/1.00, between from 1.10/1.00 to 1.90/1.00, between from 1.10/1.00 to 1.80/1.00, between from 1.10/1.00 to 1.70/1.00, between from 1.10/1.00 to 1.60/1.00, between from 1.10/1.00 to 1.50/1.00 or even between from 1.10/1.00 to 1.40/1.00.

In some embodiments, the amine end groups of the polyamide resin may include between from 1 mole percent to 100 mole percent, between from 10 mole percent to 100 mole percent, between from 20 mole percent to 100 mole percent between from 30 mole percent to 100 mole percent, between from 40 mole percent to 100 mole percent, between from 50 mole percent to 100 mole percent, between from 60 mole percent to 100 mole percent or even between from 70 mole percent to 100 mole percent of primary amine end-groups.

In some embodiments, the amine number of the polyamide resin may be between from 1 to 80 mg KOH/g, between from 2 to 22 mg KOH/g or even between from 5 to 15 mg KOH/g.

The polyamide resins of the present disclosure are capable of curing the curable compositions of the present disclosure without the use of catalyst or other cure agents. In some embodiments, a secondary cure agent may be used.

The polyamide resins of the present disclosure, which contain the dicarboxylic dimer acid at least a mole fraction of 0.1, based on the total moles of dicarboxylic acid used to form the polyamide resin, have unique properties compared to polyamides that do not include the dicarboxylic dimer acid. The polyamide resins are characterized by low or a complete lack of crystallinity, low softening points and, generally, low transition temperature ranges (melting temperature and low glass transition temperature). These properties contrast the highly crystalline nylon based polyamides known in the art that typically are highly crystalline with high melting temperatures. In some embodiments, the polyamide resin is a non-crystalline polyamide resin. It has been found that when the polyamide resins of the present disclosure are used as a curative for the benzoxazine resins, e.g. bis-A-benzoxazine and/or bis-F-benzoxazine, the resulting cured composition has surprisingly high glass transition temperatures, above 220° C., 230° C. or even above 240° C. and improved flexibility and toughness. The resulting properties make the curable compositions suitable for a variety of applications, e.g. use as a high temperature protective coating for metals. In some embodiments, the polyamide resin is a liquid at room temperature. In some embodiments, the polyamide resin is a solid, e.g. a powder, at room temperature.

Useful commercially available polyamide resins include those available under the trade designation MACROMELT. e.g. MACROMELT OM 633, MACROMELT OM 641. MACROMELT OM 652, MACROMELT OM 673, MACROMELT OM 6208, MACROMELT 7001, MACROMELT 7002, MACROMELT 7003 from Henkel Corp., Rocky Hill, Conn.: those available under the trade designation UNI-REZ 2600 series, e.g. UNI-REZ 2620, and UNI-REZ 2700 series, e.g. UNI-REZ 2720, from Arizona Chemical LLC, Jacksonville, Fla.; and those available under the trade designation VERSAMID, e.g. VERSAMID 100 and VERSAMID 115×70, from Gabriel Performance Chemicals, Ashtabula, Ohio. Other useful polyamide reins are disclosed in U.S. Pat. Nos. 3,377,303; 3,242,141; and 3,483,237, which are incorporated herein by reference in their entireties.

The curable compositions of the present disclosure include a benzoxazine resin and a polyamide resin, wherein the polyamide resin is a reaction product of (i) a dicarboxylic acid, wherein the dicarboxylic acid includes a non-aromatic, dicarboxylic dimer acid and the mole fraction of the non-aromatic, dicarboxylic dimer acid is between from 0.10 to 1.00, based on the total moles of dicarboxylic acid used to form the polyamide resin, and (ii) a diamine. The polyamide resin is amine terminated and includes amine end-groups. The weight ratio of the benzoxazine resin to the polyamide resin is selected based on the desired end use properties. Generally, the greater the amount of the benzoxazine resin, the higher the glass transition temperature and high temperature stability of the cured, curable composition. In some embodiments the weight ratio of benzoxazine resin to polyamide resin may be between from 95/5 to 20/80, between from 95/5 to 30/70, between from 95/5 to 40/60, between from 85/15 to 20/80, between from 85/15 to 30/70, between from 85/5 to 40/60, between from 75/25 to 20/80, between from 75/25 to 30/70 or even between from 75/25 to 40/60. The curable composition, is capable of exhibiting good flexural properties. In some embodiments, the curable composition is capable of being cured to form a cured composition, in the form of a film between from 250 microns to 1000 microns thick, wherein the film is capable of bending around a cylindrical rod having a radius of 5 mm, without cracking.

The curable composition may be prepared by mixing the benzoxazine resin and the polyamide resin together at a temperature below the cure temperature of the curable composition. In some embodiments, the benzoxazine resin and the polyamide resin are mixed together at a temperature between from 20° C. to 180° C., between from 20° C. to 170° C., between from 20° C. to 160° C., between from 20° C. to 150° C., between from 20° C. to 140° C., between from 20° C. to 120° C., between from 50° C. to 180° C., between from 50° C. to 170° C., between from 50° C. to 160° C., between from 50° C. to 150° C., between from 50° C. to 140° C., between from 50° C. to 120° C., between from 100° C. to 180° C., between from 80° C. to 170° C., between from 80° C. to 160° C., between from 80° C. to 150° C., between from 80° C. to 140° C. or even between from 80° C. to 120° C. If one or both of the benzoxazine resin and the polyamide resin are a solid at room temperature, one or both of the resins may be ground into a fine powder, prior to mixing, to aid in the mixing process. During mixing, the resins may be heated to a temperature that allow liquid flow of each component, yet below the curing temperature, thereby forming a melt blend. The melt blend, when cool, may solidify and may itself be ground into a fine powder to aid in later coating of the curable composition on a substrate, by, for example, electrostatic coating. Formation of the benzoxazine resin/polyamide resin melt blend, via mixing the components when both are in a liquid state is preferable, as the components may be mixed on a molecular level, prior to curing the curable compositions. This may lead to improve cure characteristic of the curable composition, compared to a mixture wherein one or both of the benzoxazine resin and the polyamide resin are a solid, e.g. a solid in powder form, during the mixing process, and are never brought to a temperature to allow liquid flow of both components. In this case one or both of benzoxazine resin particles and the polyamide resin particles would still be present in the curable composition. In some embodiments, the curable composition is a melt blend including a benzoxazine resin and a polyamide resin according to the present disclosure. By melt blend, it is meant that the benzoxazine resin and a polyamide resin are mixed at a temperature which allows liquid flow of both the benzoxazine resin and polyamide resin. In some embodiments, the curable composition is free of polyamide resin particles. In some embodiments, the curable composition is free of benzoxazine resin particles. In some embodiments, the curable composition is free of benzoxazine resin particles and polyamide resin particles.

The curable composition of the present disclosure is cured when the benzoxazine resin of the present disclosure is cured when the benzoxazine ring is ring-opened by the amine end-groups of the polyamide resin. Typically, curing is conducted at elevated temperature. In some embodiments the curable composition is capable of being cured at a temperature between from 200° C. to 300° C., between from 200° C. to 280° C., or even between from 200° C. to 260° C. In some embodiments the curable composition is cured at a temperature between from 200° C. to 300° C., between from 200° C. to 280° C., or even between from 200° C. to 260° C. The resulting cured composition may have a glass transition temperature between from 200° C. to 300° C. In some embodiments the curable compositing is capable of being cured to form a cured composition having a glass transition temperature between from 200° C. to 300° C., between from 200° C. to 280° C., between from 200° C. to 260° C., between from 210° C. to 300° C., between from 210° C. to 280° C., between from 210° C. to 260° C., between from 220° C. to 300° C., between from 220° C. to 280° C., between from 220° C. to 260° C., between from 230° C. to 300° C., between from 230° C. to 280° C., between from 230° C. to 260° C., between from 240° C. to 300° C., between from 240° C. to 280° C. or even between from 240° C. to 260° C. In some embodiments, the curable composition is capable of being cured at a temperature between from 200° C. to 260° C. to form a cured composition having a glass transition temperature between from 200° C. to 300° C., between from 200° C. to 280° C. or even between from 200° C. to 260° C.

In some embodiments, an acid catalyst may be used to promote the ring-opening of the benzoxazine. Lewis and Brönsted acids accelerate the amine cure of benzoxazine adducts as indicated by the lower onset of polymerization temperature and reduced temperature of the peak of the exotherm corresponding to the cure. Suitable acid catalysts include, but are not limited to: strong inorganic acids such as hydrochloric acid, sulfuric acid, phosphoric acid, and the like; and organic acids such as acetic acid, para-toluene sulfonic acid, and oxalic acid. Acid catalysts may be used in amounts of 2 wt. % or less, preferably 1 wt. % or less, most preferably 0.5 wt. % or less, relative to the amounts of benzoxazine reactants.

In some embodiment, a secondary cure agent, capable of curing the curable composition, may be included in the curable composition. Examples of suitable secondary cure agents include multifunctional amines and multifunctional alcohols. The term “multifunctional” is meant to include di-, tri-, tetra-, penta-, hexa- and even higher functionalities. Examples of suitable multi-functional amines and multi-functional alcohols are disclosed in U.S. Pat. No. 9,228,112 B2 and U.S. Pat. Appl. Publ. No. 2015/0031819, both of which are incorporated herein by reference in their entirety. Additionally, the diamines previously discussed in the formation of the benzoxazine resins of the present disclosure may also be useful a secondary cure agent. In some embodiments, the multifunctional amine may be dicyandiamide. In some embodiments, the curable composition includes a secondary cure agent capable of curing the benzoxazine resin, wherein the ratio of the moles of secondary cure agent to the moles of the polyamide resin is between from 0.001 to 0.5, between from 0.01 to 0.5, between from 0.1 to 0.5, between from 0.001 to 0.3, between from 0.01 to 0.3, between from 0.1 to 0.3, between from 0.001 to 0.1 or even between from 0.01 to 0.1. In some embodiments, the secondary cure agent is at least one of a multifunctional amine and a multifunctional alcohol.

The curable composition may further comprise an epoxy resin, which may improved the moisture-resistance of the cured coatings. Polyepoxy compounds which can be utilized in the composition of the invention include both aliphatic and aromatic polyepoxides, but glycidyl aliphatic epoxides are preferred. The aromatic polyepoxides are compounds containing at least one aromatic ring structure, e.g. a benzene ring, and more than one epoxy group. Preferred aromatic polyepoxides include the polyglycidyl ethers of polyhydric phenols (e.g., bisphenol A derivative resins, epoxy cresol-novolac resins, bisphenol F derivative resins, epoxy phenol-novolac resins) and the glycidyl esters of aromatic carboxylic acids. The most preferred aromatic polyepoxides are the polyglycidyl ethers of polyhydric phenols.

Representative examples of aliphatic polyepoxides which can be utilized in the composition of the invention include 3′,4′-epoxycyclohexylmethyl-3,4-epoxycyclohexanecarboxylate, 3,4-epoxycyclohexyloxirane, 2-(3′,4′-epoxycyclohexyl)-5, IH-spiro-3 H 4 H-epoxycyclohexane-1,3-dioxane, bis(3,4-epoxycyclohexylmethyl)adipate, the diglycidyl ester of linoleic dimer acid, 1,4-bis(2,3-epoxypropoxy)butane, 4-(1,2-epoxyethyl)-1,2-epoxycyclohexane, 2,2-bis(3,4-epoxycyclohexyl)propane, polyglycidyl ethers of aliphatic polyols such as glycerol or hydrogenated 4,4′-dihydroxydiphenyl-dimethylmethane, and mixtures thereof.

Representative examples of aromatic polyepoxides which can be utilized in the composition of the invention include glycidyl esters of aromatic carboxylic acids, e.g., phthalic acid diglycidyl ester, isophthalic acid diglycidyl ester, trimellitic acid triglycidyl ester, and pyromellitic acid tetraglycidyl ester, and mixtures thereof; N-glycidylaminobenzenes, e.g., N,N-diglycidylbenzeneamine, bis(N,N-diglycidyl-4-aminophenyl)methane, 1,3-bis(N,N-diglycidylamino)benzene, and N,N-diglycidyl-4-glycidyloxybenzeneamine, and mixtures thereof; and the polyglycidyl derivatives of polyhydric phenols, e.g., 2,2-bis-(4-(2,3-epoxypropoxy)phenylpropane, the polyglycidyl ethers of polyhydric phenols such as tetrakis(4-hydroxyphenyl)ethane, pyrocatechol, resorcinol, hydroquinone, 4,4′-dihydroxydiphenyl methane, 4,4′-dihydroxydiphenyl dimethyl methane, 4,4′-dihydroxy-3,3′-dimethyldiphenyl methane, 4,4′-dihydroxydiphenyl methyl methane, 4,4′-dihydroxydiphenyl cyclohexane, 4,4′-dihydroxy-3,31-dimethyldiphenyl propane, 4,4′-dihydroxydiphenyl sulfone, and tris-(4-hydroxyphenyl)methane, polyglycidyl ethers of novolacs (reaction products of monohydric or polyhydric phenols with aldehydes in the presence of acid catalysts), and the derivatives described in U.S. Pat. Nos. 3,018,262 and 3,298,998, as well as the derivatives described in the Handbook of Epoxy Resins by Lee and Neville, McGraw-Hill Book Co., New York (1967), and mixtures thereof.

A preferred class of polyepoxy compounds are polyglycidyl ethers of polyhydric alcohol, particularly polyphenols. The glycidyl epoxy compounds are generally more reactive toward amines than cycloaliphatic epoxy compounds. In some preferred embodiments, the epoxy compound generally has an epoxy equivalent weight (EW) of between from 170 to 4,000, preferably between from 170 to 1,000. The epoxide equivalent weight (EW) is defined as the weight in grams of the epoxy functional compound that contains one gram equivalent of epoxy (oxirane) functional groups.

Epoxy resins may be compounded with the benzoxazine component in amounts of 5 to 25% molar equivalents of epoxy functional groups to moles of benzoxazine functional groups.

Adjuvants may optionally be added to the curable compositions such as colorants, abrasive granules, anti-oxidant stabilizers, thermal degradation stabilizers, light stabilizers, conductive particles, tackifiers, flow agents, bodying agents, flatting agents, inert fillers, binders, blowing agents, fungicides, bactericides, surfactants, plasticizers, rubber tougheners and other additives known to those skilled in the art. They also can be substantially unreactive, such as fillers, both inorganic and organic. These adjuvants, if present are added in an amount effective for their intended purpose.

Examples of suitable filler materials include silica-based fillers, reinforcement-grade carbon black, clays, and any combination of any of these in any proportions. Such fillers are described in more detail below.

In some embodiments, a toughening agent may be used. The toughening agents which are useful in the present invention are polymeric compounds having both a rubbery phase and a thermoplastic phase such as: graft polymers having a polymerized, diene, rubbery core and a polyacrylate, polymethacrylate shell; graft polymers having a rubbery, polyacrylate core with a polyacrylate or polymethacrylate shell; and elastomeric particles polymerized in situ in the benzoxazine resin from free radical polymerizable monomers and a copolymerizable polymeric stabilizer.

Examples of useful toughening agents of the first type include graft copolymers having a polymerized, diene, rubbery backbone or core to which is grafted a shell of an acrylic acid ester or methacrylic acid ester, monovinyl aromatic hydrocarbon, or a mixture thereof, such as disclosed in U.S. Pat. No. 3,496,250 (Czerwinski), incorporated herein by reference. Preferable rubbery backbones comprise polymerized butadiene or a polymerized mixture of butadiene and styrene. Preferable shells comprising polymerized methacrylic acid esters are lower alkyl (C₁-C₄) substituted methacrylates. Preferable monovinyl aromatic hydrocarbons are styrene, alphamethylstyrene, vinyltoluene, vinylxylene, ethylvinylbenzene, isopropylstyrene, chlorostyrene, dichlorostyrene, and ethylchlorostyrene. It is important that the graft copolymer contain no functional groups that would poison the catalyst.

Examples of useful toughening agents of the second type are acrylate core-shell graft copolymers wherein the core or backbone is a polyacrylate polymer having a glass transition temperature below about 0° C., such as polybutyl acrylate or polyisooctyl acrylate to which is grafted a polymethacrylate polymer (shell) having a glass transition above about 25° C., such as polymethylmethacrylate.

The third class of toughening agents useful in the invention comprises elastomeric particles that have a glass transition temperature (T_{g}) below about 25° C. before mixing with the other components of the composition. These elastomeric particles are polymerized from free radical polymerizable monomers and a copolymerizable polymeric stabilizer that is soluble in the benzoxazine. The free radical polymerizable monomers are ethylenically unsaturated monomers or diisocyanates combined with coreactive difunctional hydrogen compounds such as diols, diamines, and alkanolamines.

Useful toughening agents include core/shell polymers such as methacrylate-butadiene-styrene (MBS) copolymer wherein the core is crosslinked styrene/butadiene rubber and the shell is polymethylacrylate (for example, ACRYLOID KM653 and KM680, available from Rohm and Haas, Philadelphia, Pa.), those having a core comprising polybutadiene and a shell comprising poly(methyl methacrylate) (for example, KANE ACE M511, M521, B11A, B22, B31, and M901 available from Kaneka Corporation, Houston, Tex. and CLEARSTRENGTH C223 available from ATOFINA, Philadelphia, Pa.), those having a polysiloxane core and a polyacrylate shell (for example, CLEARSTRENGTH S-2001 available from ATOFINA and GENIOPERL P22 available from Wacker-Chemie GmbH, Wacker Silicones, Munich, Germany), those having a polyacrylate core and a poly(methyl methacrylate) shell (for example, PARALOID EXL2330 available from Rohm and Haas and STAPHYLOID AC3355 and AC3395 available from Takeda Chemical Company, Osaka, Japan), those having an MBS core and a poly(methyl methacrylate) shell (for example, PARALOID EXL2691A, EXL2691, and EXL2655 available from Rohm and Haas); and the like; and mixtures thereof. Preferred modifiers include the above-listed ACRYLOID and PARALOID modifiers; and the like; and mixtures thereof.

The toughening agent is useful in an amount equal to about 3-35%, preferably about 5-25%, based on the weight of the benzoxazine resin. The toughening agents of the instant invention add strength to the composition after curing without reacting with the benzoxazine or interfering with curing of the curable composition.

The curable compositions are useful for coatings, foams, shaped articles, adhesives (including structural and semistructural adhesives), magnetic media, filled or reinforced composites, coated abrasives, caulking and sealing compounds, casting and molding compounds, potting and encapsulating compounds, impregnating and coating compounds, conductive adhesives for electronics, protective coatings for electronics, as primers or adhesion-promoting layers, and other applications that are known to those skilled in the art. In some embodiments, the present disclosure provides an article comprising a substrate, having a cured coating of the curable composition thereon.

In some embodiments, the curable composition may function as a structural adhesive, i.e. the curable composition is capable of bonding a first substrate to a second substrate, after curing. Generally, the bond strength (e.g. peel strength, overlap shear strength, or impact strength) of a structural adhesive continues to build well after the initial cure time. For example, it may take hours or even days for the adhesive to reach its ultimate strength. In some embodiments, the curable composition may be a one-part adhesive. In some embodiments, the curable composition may be a two-part adhesive. In some embodiments, the present disclosure provides an article comprising a first substrate, a second substrate and a cured composition disposed between and adhering the first substrate to the second substrate, wherein the cured composition is the reaction product of the curable composition according to any one of the curable compositions of the present disclosure. In some embodiments, the first and/or second substrate may be at least one of a metal, a ceramic and a polymer, e.g. a thermoplastic.

In another embodiment, the present disclosure provides an article including a cured composition, wherein the cured composition is the reaction product of the curable composition according to any one of the curable compositions of the present disclosure, optionally, wherein at least 10 mole percent of the amine end-groups of the polyamide resin of the curable composition have reacted, i.e. have reacted with the benzoxazine resin. In some embodiments, an article includes the reaction product of the curable composition, wherein at least 10 mole percent, at least 30 mole percent, at least 50 mole percent at least 70 mole percent, at least 90 mole percent or even at least 95 mole percent of the amine end-groups of the polyamide resin of the curable composition have reacted. In some embodiments, the cured composition may have a glass transition temperature between from 200° C. to 300° C., between from 200° C. to 280° C., between from 200° C. to 260° C., between from 210° C. to 300° C., between from 210° C. to 280° C., between from 210° C. to 260° C., between from 220° C. to 300° C., between from 220° C. to 280° C., between from 220° C. to 260° C., between from 230° C. to 300° C., between from 230° C. to 280° C., between from 230° C. to 260° C., between from 240° C. to 300° C., between from 240° C. to 280° C. or even between from 240° C. to 260° C. In some embodiments, the cured composition is in the form of a film between from 250 microns to 1000 microns thick, wherein the film is capable of bending around a cylindrical rod having a radius of 10 mm, 5 mm, or even 3 mm, without cracking. In some embodiments, the cured composition has a thickness between from 5 microns to 10000 microns, between from 5 microns to 5000 microns, between from 5 microns to 1000 microns, between from 50 microns to 10000 microns, between from 50 microns to 5000 microns, between from 50 microns to 1000 microns, between from 100 microns to 10000 microns, between from 100 microns to 5000 microns, between from 100 microns to 1000 microns.

In some embodiments, the article including the cured composition may further include a substrate having a surface, wherein the cured composition is disposed on the surface of the substrate, optionally, the surface of the substrate may include a primer, e.g. a phenolic resin. The surface of the substrate may be at least one of a planar surface and a curved surface. In some embodiments, the curved surface includes at least one of the interior curved surface and exterior curved surface of a pipe.

The curable compositions may be coated onto substrates at useful thicknesses ranging from 25-10000 micrometers or more. Coating can be accomplished by any conventional means such as roller, dip, knife, or extrusion coating. Solutions of the curable composition may be used to facilitate coating. Powders of the curable composition may also be used to facilitate coating. Stable thicknesses may be necessary to maintain the desired coating thickness prior to curing of the curable composition by heat and/or acid catalysis.

The curable composition may also be powder coated by partially curing the curable compositions, crushing or grinding the partially cured, curable composition to a suitable particle size and fusing to a heated substrate. The powder coatings are prepared by well-known methods basically through the steps of pre-mixing the ingredients, melt extrusion of the blend and pulverization. The extruder is preferably a twin screw extruder for this process. The powder is applied by conventional powder coating techniques. Non-limiting examples of powder coating techniques include electrostatic spray coating and fluidized bed coating.

In another embodiment, the present disclosure provides a method of coating a substrate including providing a curable composition according to any one of the curable compositions of the present disclosure, wherein the curable composition is in the form of a powder, curable composition; providing a substrate having a surface; coating the powder, curable composition onto the substrate surface; and optionally, curing the powder, curable composition. In some embodiments, the coating may be electrostatic coating.

In some embodiments the powder, curable composition may be sprayed onto a heated substrate to fuse and further cure the composition. Electrostatic spray is a useful process for applying powder coatings. An electrostatic spray gun consists essentially of a tube to carry airborne powder to an orifice with an electrode located at the orifice. The electrode is connected to a high-voltage (about 5-100 kv), low-amperage power supply. As the powder particles come out of the orifice they pass through a cloud of ions, called a corona and pick up a negative or positive electrostatic charge. The object to be coated is electrically grounded. The difference in potential attracts the powder particles to the surface of the part. They are attracted most strongly to areas that are not already covered, forming a reasonably uniform layer of powder even on irregularly shaped objects.

The particles cling to the surface strongly enough and long enough for the object to be conveyed to a baking oven, where the powder particles fuse to form a continuous film, flow, and further cured. The powder particles that do not adhere to the object to be coated (overspray) can be recovered and recycled, typically, by blending with virgin powder.

In another embodiment the powder coating may be applied by dipping the heated substrate into a fluidized bed containing the curable composition or a partially cured, curable composition.

Useful substrates can be of any nature and composition, and can be inorganic or organic. Representative examples of useful substrates include ceramics, siliceous substrates including glass, metal, natural and man-made stone, woven and nonwoven articles, polymeric materials, including thermoplastic and thermosets, (such as polymethyl (meth)acrylate, polycarbonate, polystyrene, styrene copolymers, such as styrene acrylonitrile copolymers, polyesters, polyethylene terephthalate), silicones, paints (such as those based on acrylic resins), powder coatings (such as polyurethane or hybrid powder coatings), and wood; and composites of the foregoing materials.

The cured composition may be used as an anticorrosion coating to protect metal substrates. Coatings used to protect metals against corrosion are required to meet several important criteria. They should be durable so as to avoid damage to the coated product during transportation or storage and they should not craze or crack or otherwise fail when subjected to bending or other forms of distortion. They should possess excellent abrasion and impact resistance and can be formulated to aggressively adhere to cleaned metal surfaces. Further, they should be able to survive most of the exacting conditions for corrosion protection coatings.

In another aspect, the present disclosure provides a coated article comprising a metal substrate comprising a coating of the uncured, partially cured or fully cured curable composition on at least one surface thereof. If the substrate has two major surfaces, the coating can be coated on one or both major surfaces of the metal substrate and can comprise additional layers, such as bonding, tying, protective, and topcoat layers. The metal substrate can be, for example, at least one of the inner and outer surfaces of a pipe, vessel, conduit, rod, profile shaped article, sheet or tube. The compositions are useful in providing a corrosion protected pipe, vessel, conduit, rod, profile shaped article, sheet or tube that transport or are exposed (on any surface) to fluids at different temperatures and pressures and having different chemical compositions. Layers of the coating can provide corrosion protection to the metal substrate and act as a thermal insulator. Protected articles of the invention also have resistance to chipping (on impact), are flexible enough to allow for bending of the substrate without cracking or delamination, and have improved abrasion resistance. Multilayers of the coating can be coated individually in sequence or simultaneously.

Unexpectedly, the cured composition provides an excellent protective layer, even at elevated temperatures, when coated directly onto a metal surface, such as a steel pipe. Metal surfaces coated with cured composition layers having a dried thickness in the range of 0.02 mm to 300 mm, preferably in the range of 0.5 mm to 5 mm, show superior impact resistance and superior cohesion compared to known conventional coated metal pipes, vessels, conduits, profile shaped articles, sheets rods, or tubes.

Additionally, the cured composition is advantageous over conventional coatings on metal surfaces in that the benzoxazine compositions have strong bonding ability to without requiring the use of intervening adhesive layers. For example, in some embodiments a pipe, vessel, conduit, rod, profile shaped article, sheet or tube can be directly coated with the curable composition and then overcoated with a thermoplastic topcoat protective/insulative layer, thus providing a two-layer system on a metal substrate showing excellent adhesion to the metal surface and excellent cohesion of the coated layers. This system provides processing and economic advantages. Also, the article of the present invention comprising the cured composition exhibit improved cathodic disbandment performance at elevated temperatures and impact resistance compared to conventional thermoplastic or thermosetting polymer coated metal substrates. There has been achieved better interlayer adhesion than is known in the art for similar articles.

Select embodiments of the present disclosure include, but are not limited to, the following:

In a first embodiment, the present disclosure provides a curable composition comprising: a benzoxazine resin and a polyamide resin, wherein the polyamide resin is a reaction product of (i) a dicarboxylic acid, wherein the dicarboxylic acid includes a non-aromatic, dicarboxylic dimer acid and the mole fraction of the non-aromatic, dicarboxylic dimer acid is between from 0.10 to 1.00, based on the total moles of dicarboxylic acid used to form the polyamide resin; and (ii) a diamine; and wherein the polyamide resin is amine terminated and includes amine end-groups.

In a second embodiment, the present disclosure provides a curable composition according to the first embodiment, wherein the number average molecular weight of the non-aromatic, dicarboxylic dimer acid is between from 300 g/mol to 1400 g/mol.

In a third embodiment, the present disclosure provides a curable composition according to the first or second embodiments, wherein the number of carbon atoms in the non-aromatic, dicarboxylic dimer acid is between from 12 to 100.

In a fourth embodiment, the present disclosure provides a curable composition according to any one of the first through third embodiments, wherein the weight ratio of the benzoxazine resin to the polyamide resin is between from 95/5 to 20/80.

In a fifth embodiment, the present disclosure provides a curable composition according to any one of the first through fourth embodiments, wherein the number average molecular weight of the diamine is between from 60 g/mol to 10000 g/mol.

In a sixth embodiment, the present disclosure provides a curable composition according to any one of the first through fifth embodiments, wherein the mole ratio of the diamine to dicarboxylic acid is between from 1.01/1.00 to 2.0/1.00.

In a seventh embodiment, the present disclosure provides a curable composition according to any one of the first through sixth embodiments, wherein between from 10 mole percent to 100 mole percent of the amine end-groups are primary amine end-groups.

In an eighth embodiment, the present disclosure provides a curable composition according to any one of the first through seventh embodiments, wherein the diamine is free of an aryl moiety.

In a ninth embodiment, the present disclosure provides a curable composition according to any one of the first through eighth embodiments, wherein the polyamide resin is a non-crystalline polyamide resin.

In a tenth embodiment, the present disclosure provides a curable composition according to any one of the first through ninth embodiments, wherein the curable composition is free of polyamide resin particles.

In an eleventh embodiment, the present disclosure provides a curable composition according to any one of the first through tenth embodiments, further comprising a secondary cure agent capable of curing the benzoxazine resin, wherein the ratio of the moles of secondary cure agent to the moles of the polyamide resin is between from 0.001 to 0.5.

In a twelfth embodiment, the present disclosure provides a curable composition according to the eleventh embodiment, wherein the secondary cure agent is at least one of a multifunctional amine and a multifunctional alcohol.

In a thirteenth embodiment, the present disclosure provides a curable composition according to the twelfth embodiment, wherein the multifunctional amine is dicyandiamide.

In a fourteenth embodiment, the present disclosure provides a curable composition according to any one of the first through thirteenth embodiments, wherein the curable composition is capable of being cured at a temperature between from 200° C. to 260° C. to form a cured composition having a glass transition temperature between from 200° C. to 300° C.

In a fifteenth embodiment, the present disclosure provides a curable composition according to any one of the first through fourteenth embodiments, wherein the composition is capable of being cured to form a cured composition in the form of a film between from 250 microns to 1000 microns thick, wherein the film is capable of bending around a cylindrical rod having a radius of 5 mm, without cracking.

In a sixteenth embodiment, the present disclosure provides an article comprising a cured composition, wherein the cured composition is the reaction product of the curable composition according to any one of the curable compositions of the first through fifteenth embodiments, optionally, wherein at least 10 mole percent of the amine end-groups of the polyamide resin of the curable composition have reacted.

In a seventeenth embodiment, the present disclosure provides an article according to the sixteenth embodiment, wherein the cured composition has a glass transition temperature between from 200 degrees centigrade to 300 degrees centigrade.

In an eighteenth embodiment, the present disclosure provides an article according to the sixteenth or seventeenth embodiments, wherein the cured composition, in the form of a film between from 250 microns to 1000 microns thick, is capable of bending around a cylindrical rod having a radius of 5 mm, without cracking.

In a nineteenth embodiment, the present disclosure provides an article according to the sixteenth or seventeenth embodiments, wherein the cured composition has a thickness between from 5 microns to 10000 microns.

In a twentieth embodiment, the present disclosure provides an article according to the sixteenth through nineteenth embodiments further comprising a substrate having a surface, wherein the cured composition is disposed on the surface of the substrate.

In a twenty-first embodiment, the present disclosure provides an article according to the twentieth embodiment, wherein the surface of the substrate includes a primer.

In a twenty-second embodiment, the present disclosure provides an article according to the twenty-first embodiment, wherein the primer is a phenolic resin.

In a twenty-third embodiment, the present disclosure provides an article according to any one of the twentieth through twenty-second embodiments, wherein the substrate is a metal substrate.

In a twenty-fourth embodiment, the present disclosure provides an article according to any one of the twentieth through twenty-third embodiments, wherein the surface of the substrate includes at least one of a planar surface and curved surface.

In a twenty-fifth embodiment, the present disclosure provides an article according to the twenty-fourth embodiment, wherein the curved surface includes at least one of the interior curved surface and exterior curved surface of a pipe.

In a twenty-sixth embodiment, the present disclosure provides an article comprising a first substrate, a second substrate and a cured composition disposed between and adhering the first substrate to the second substrate, wherein the cured composition is the reaction product of the curable composition according to any one of the first through fifteenth embodiments.

In a twenty-seventh embodiment, the present disclosure provides an article according to the twenty-sixth embodiment, wherein the first or second substrate is at least one of a metal, a ceramic and a polymer.

In a twenty-eighth embodiment, the present disclosure provides an article according to the twenty-sixth embodiment, wherein the first and second substrate is at least one of a metal, a ceramic and a polymer.

In a twenty-ninth embodiment, the present disclosure provides a method of coating a substrate comprising (i) providing a curable composition according to any one of the first through fifteen embodiments, wherein the curable composition is in the form of a powder, curable composition, (ii) providing a substrate having a surface, (iii) coating the powder, curable composition onto the substrate surface, and optionally, (iv) curing the powder, curable composition.

### EXAMPLES

Curable compositions and coated articles were prepared by using powder spray coating methods and fluidized bed dipping. The curable compositions (powder) were made by mixing, extrusion compounding, grinding and classifying. The resultant constructions provide coated articles with properties that are suitable for harsh environments in downhole pipelines and other high temperature applications.

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company, St. Louis, Mo. unless otherwise noted. The following abbreviations are used herein: N=newtons, Hz=hertz, MPa=megapascal, g=gram, V=volt, mV=millivolt, mm=millimeters, cm=centimeters, pm=micrometers, in =inch, psi=pounds per square inch and min=minute.

### Materials:

| Abbreviation | Description |
|---|---|
| R | Bis-F-Benzoxazine Resin, available under the trade |
| | designation “ARALDITE 37500MT” from Hunstman, The |
| | Woodlands, Texas. |
| C | Cyanoguanidine, available under the trade designation |
| | “DICYANDIAMIDE” from The Chemical Company, |
| | Jamestown, Rhode Island. |
| AP | Ortho-dihydroxyaryl component consisting of a 20:80 blend |
| | of catechol novolak resin and phenolic hardener resin, |
| | equivalent to the “ACN blend” described in U.S. Pat. No. |
| | 6,911,512 (Jing et al.). |
| F1 | 3M Silicon carbide nanofiller Grade 0.7, available from |
| | ESK Ceramics GmbH, a 3M Company. |
| F2 | 3M Silicon carbide nanofiller Grade 0.15, available from |
| | ESK Ceramics GmbH, a 3M Company. |
| F3 | Fused silica, available under the trade designation “3M |
| | Fused Silica 20” from 3M Company, St. Paul, Minnesota. |
| F4 | Fumed silica, available under the trade designation |
| | “CAB-O-SIL TS-720” from Cabot Corporation, Alpharetta, |
| | Georgia. |
| CT | An amine terminated polyamide resin having an amine |
| | number of 5.6 mg KOH/g, prepared according to Example |
| | I of U.S. Pat. No. 3,377,303 (Peerman et al.). |
| FM | Flow modifier, available under the trade designation |
| | “MODAFLOW POWDER 6000” from Allnex, Alpharetta, |
| | Georgia. |
| T | Amine-functional butadiene copolymer, available under |
| | the trade designation “HYPRO1300X42 ATBN” from |
| | CVC Thermoset Specialties, Moorestwon, New Jersey. |

### Test Methods

### Dynamic Mechanical Analysis (DMA)

DMA was employed to determine the glass transition temperature (T_{g}), the onset of the storage modulus E′, the peak of the loss modulus E″, and the tan delta peak, of the Example Formulations. A DMA Q800 (TA Instruments, New Castle, Del.) was used in the multi-frequency strain setting, requiring thin rectangular strips of the coating loaded in tension. To obtain the freestanding coating required to perform the test, 4 in×4 in×0.25 in (10.2 cm×10.2 cm×0.64 cm) steel coupons were covered with silicon tape (3M 1280 Scotch Brand), and then dip coated in a fluidized bed, as described in the “SAMPLE PREPARATION” section below. Curing was performed for 60 min at temperatures (230° C. and 250° C.) to determine which curing condition produced the highest T_{g}. Post-curing, the coating was able to be sliced into thin rectangular samples and peeled off the coupons to be placed in the testing apparatus. The conditions used in the Q800 DMA were the following: amplitude of 5 μm, preload force of 0.005 N, and frequency of 1 Hz. The temperature ramp began at 25° C. and increased to 350° C. at a rate of 2° C. per minute.

### Chemical Resistance

Chemical testing: Cold roll steel bars, coated with cured formulations (see “SAMPLE PREPARTION”, below), were dipped in the respective solutions (30% sulfuric acid, 10% brine solution, and toluene: kerosene (50:50)) for 1 month at room temperature. For distilled water immersion testing, the bars were immersed in a container and heated to either 65° C. or 100° C. and held at that temperature for 1 month. The bars were removed, rinsed with distilled water, dried and inspected for blistering and delamination. A yes (Y) result indicates that the associated defect was observed. A no (N) result indicates that the associated defect was not observed.

### Autoclave

For autoclave testing, the bars coated with the cured formulations (see “SAMPLE PREPARTION”, below) were immersed in ⅓ by volume CO₂, ⅓ by volume toluene: kerosene (50:50 vol:vol) and ⅓ by volume of a 3 wt. % NaCl solution and subjected to autoclaving with 1800 psi (12.4 MPa) CO₂ at 210° C. for 96 hrs. The bars were removed and inspected for blistering and delamination. A yes (Y) result indicates that the associated defect was observed. A no (N) result indicates that the associated defect was not observed.

### Impedance

4 in×4 in×0.25 in (10.2 cm×10.2 cm×0.64 cm) steel coated coupons with about 15 mil (0.4 mm) thickness of the cured formulation were utilized for this tests (see “SAMPLE PREPARTION”, below). A Solartron SI 1287 electrochemical interface apparatus and a Solartron SI 1260 impedance gain-phase analyzer were used. The conditions prescribed by Standard: BS EN ISO 16773-1:2007 “Paints and Varnishes—Electrochemical Impedance Spectroscopy (EIS) on High—Impedance Coated Specimens” were as follows: electrolyte: 3 wt. % NaCl, sample conditioning: 65° C., Counter Electrode: Platinum, Reference Electrode: Calomel, Polarization Potential: AC+/−100 mV perturbation (Standard calls for −20 mV but can change at discretion, as it needs to be in the pseudo linear region), Frequency: Initial: 100,000 Hz, Final: 0.1 Hz. Area of sample electrode: 35.3 cm². The software employed was ZPlot and ZView 3.3e from Scribner Associates. A Randles model was utilized. Impedance results are reported as ohm-cm at 2 hours and 28 days.

### Sample Preparation

### Formulations:

Powder chemicals (Table 1) were thoroughly mixed and extruded with use of a twin screw extruder. The extruder was a 30 mm diameter twin screw extruder model SLJ-30D made by Donghui Powder Processing Equipment Co. of Yantai, China. A temperature profile ranging from 130° C. to 150° C. was utilized. The screw speed was 100 rpm.

Flakes or sheets produced with the extruder/nip system were ground into powder as follows: Cooled extrudate in flake or sheet form was milled using a Strand Mill S102DS Lab Grinder (110 V, 60, 5 Hz from Strand Manufacturing, Hopkins, Minn., USA) and sieved through a 40 mesh screen to obtain a relatively uniform size powder.

TABLE 1
Example Formulations - Comparative Example 1 (CE1), Comparative
Example 2 (CE2) and Example 1(E1) (amounts given in grams)

| | Composition (g) | | | | | | | | | |
|---|---|---|---|---|---|---|---|---|---|---|
| Example | R | T | CT | AP | C | F3 | F1 | F2 | FM | F4 |
| CE1 | 864 | 110 | — | 69 | 50 | 69 | 56 | 80 | 4 | — |
| CE2 | 864 | 110 | — | 69 | 50 | 450 | — | — | 4 | 4 |
| E1 | 864 | — | 150 | 69 | — | 450 | — | — | 4 | 4 |

### Steel Coated Bars and Coupons Preparation:

Cold rolled steel bars 6 in×1 in×0.25 in (15.2 cm×2.54 cm×0.64 cm) and coupons 4 in×4 in×0.25 in (10.2 cm×10.2 cm×0.64 cm) were grit blasted to remove surface imperfections and build up. The bars and coupons were preheated to 175° C. for 20 min, and then coated with the powder formulations using the electrostatic powder coating gun (Voltstatic Solid Spray ‘XC’, UK) or dip coated using a fluidized bed. The bars and coupons were coated to at least a 15 mil (0.4 mm) thickness of the powder and cured initially at 175° C. for 30 min, followed by curing at 230° C. or 250° C. for 60 min. The cured bars were stored at room temperature until further testing using the test methods described above.

### Results

TABLE 2
DMA results from cured formulations.

| | | T_{g} (° C.) | |
|---|---|---|---|
| Formulation | Curing Temperature (° C.) | E′ Onset | Tan Delta Peak |
| CE1 | 250 | 203 | 273 |
| CE2 | 230 | 192 | 253 |
| CE2 | 250 | 200 | 254 |
| E1 | 230 | 186 | 239 |
| E1 | 250 | 206 | 248 |

TABLE 3
Chemical testing of coated steel bars with formulations from Table 1 cured at 250° C.

| | CE1 | | CE2 | | E1 | |
|---|---|---|---|---|---|---|
| Testing | Blistering | Delamination | Blistering | Delamination | Blistering | Delamination |
| Autoclave | Y | Y | Y | N | N | N |
| (96 hrs, 210° C., | | | | | | |
| 1800 psi | | | | | | |
| CO₂) | | | | | | |
| 30% Sulfuric | Y | N | Y | N | N | N |
| acid (1 | | | | | | |
| month) | | | | | | |
| 50:50 | Y | N | Y | N | N | N |
| Toluene:Kerosene | | | | | | |
| (1 | | | | | | |
| month) | | | | | | |
| 10% Brine (1 | N | N | N | N | N | N |
| month) | | | | | | |
| 65° C. distilled | Y | N | N | N | N | N |
| water (1 | | | | | | |
| month) | | | | | | |
| 100° C. | Y | N | N | N | N | N |
| distilled | | | | | | |
| water (1 | | | | | | |
| month) | | | | | | |

TABLE 4
Impedance results on coated steel coupons with
formulations from Table 1 cured at 250° C.

Impedance (Ohm-cm)

| Formulation | After 2 hours | After 28 days |
|---|---|---|
| CE1 | 6.78E+09 | 1.41E+09 |
| CE2 | 6.73E+09 | 4.30E+08 |
| E1 | 3.90E+09 | 1.09E+09 |

What is claimed:

1. A curable composition comprising:
a benzoxazine resin; and
a polyamide resin, wherein the polyamide resin is a reaction product of
(i) a dicarboxylic acid, wherein the dicarboxylic acid includes a non-aromatic, dicarboxylic dimer acid and the mole fraction of the non-aromatic, dicarboxylic dimer acid is between from 0.10 to 1.00, based on the total moles of dicarboxylic acid used to form the polyamide resin; and
(ii) a diamine; and
wherein the polyamide resin is amine terminated and includes amine end-groups.

2. The curable composition according to claim 1, wherein the number average molecular weight of the non-aromatic, dicarboxylic dimer acid is between from 300 g/mol to 1400 g/mol.

3. The curable composition according to claim 1, wherein the number of carbon atoms in the non-aromatic, dicarboxylic dimer acid is between from 12 to 100.

4. The curable composition according to claim 1, wherein the weight ratio of the benzoxazine resin to the polyamide resin is between from 95/5 to 20/80.

5. The curable composition according to claim 1, wherein the number average molecular weight of the diamine is between from 60 g/mol to 10000 g/mol.

6. The curable composition according to claim 1, wherein the mole ratio of the diamine to dicarboxylic acid is between from 1.01/1.00 to 2.0/1.00.

7. The curable composition according to claim 1, wherein between from 10 mole percent to 100 mole percent of the amine end-groups are primary amine end-groups.

8. The curable composition according to claim 1, wherein the diamine is free of aryl moiety.

9. The curable composition according to claim 1, wherein the polyamide resin is a non-crystalline polyamide resin.

10. The curable composition according to claim 1, wherein the curable composition is free of polyamide resin particles.

11. The curable composition according to claim 1 further comprising a secondary cure agent capable of curing the benzoxazine resin, wherein the ratio of the moles of secondary cure agent to the moles of the polyamide resin is between from 0.001 to 0.5.

12. The curable composition according to claim 11, wherein the secondary cure agent is at least one of a multifunctional amine and a multifunctional alcohol.

13. The curable composition according to claim 12, wherein the multifunctional amine is dicyandiamide.

14. The curable composition according to claim 1, wherein the curable composition is capable of being cured at a temperature between from 200° C. to 260° C. to form a cured composition having a glass transition temperature between from 200° C. to 300° C.

15. The curable composition according to claim 1, wherein the curable composition is capable of being cured to form a cured composition in the form of a film between from 250 microns to 1000 microns thick, wherein the film is capable of bending around a cylindrical rod having a radius of 5 mm, without cracking.

16. An article comprising a cured composition, wherein the cured composition is the reaction product of the curable composition according to claim 1.

17. The article of claim 16, wherein the cured composition has a glass transition temperature between from 200 degrees centigrade to 300 degrees centigrade.

18. The article of claim 16, wherein the cured composition, in the form of a film between from 250 microns to 1000 microns thick, is capable of bending around a cylindrical rod having a radius of 5 mm, without cracking.

19. The article of claim 16, wherein the cured composition has a thickness between from 5 microns to 10000 microns.

20. The article of claim 16 further comprising a substrate having a surface, wherein the cured composition is disposed on the surface of the substrate.

21. The article of claim 20, wherein the surface of the substrate includes a primer.

22. The article of claim 21, wherein the primer is a phenolic resin.

23. The article of claim 20, wherein the substrate is a metal substrate.

24. The article of claim 20, wherein the surface of the substrate includes at least one of a planar surface and curved surface.

25. The article of claim 24, wherein the curved surface includes at least one of the interior curved surface and exterior curved surface of a pipe.

26. An article comprising a first substrate, a second substrate and a cured composition disposed between and adhering the first substrate to the second substrate, wherein the cured composition is the reaction product of the curable composition according to claim 1.

27. The article of claim 26, wherein the first or second substrate is at least one of a metal, a ceramic and a polymer.

28. The article of claim 26, wherein the first and second substrate is at least one of a metal, a ceramic and a polymer.

29. A method of coating a substrate comprising:
providing a curable composition according to claim 1, wherein the curable composition is in the form of a powder, curable composition;
providing a substrate having a surface;
coating the powder, curable composition onto the substrate surface; and
optionally, curing the powder, curable composition.
